(19) United States
(12) Patent Application Publication
(10) Pub. No.: US 2007/0298756 A1
(43) Pub. Date: Dec. 27, 2007

(54) OPTIMIZED ACQUISITION METHOD

(75) Inventor: Reino Juhani Hiltunen, Merimasku (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, ESPOO (FI)

(21) Appl. No.: 11/765,300

(22) Filed: Jun. 19, 2007

Related U.S. Application Data
(60) Provisional application No. 60/814,568, filed on Jun. 19, 2006.

(51) Int. Cl. H04Q 7/20; H04M 11/00

(52) U.S. Cl. 455/403

(57) ABSTRACT

Provided are apparatuses and methods for transmitting and receiving option information corresponding to a program or service such as within electronic service guide (ESG) information. The option information may include user selectable options or predetermined options and may be described in a corresponding acquisition fragment and/or SDP. Acquisition fragments and corresponding SDPs for providing option data corresponding to a program or service may be added or overwritten. In on example, a service-related option is overwritten by a schedule event-related option and a corresponding schedule event fragment in the ESG information may contain a reference to any number of acquisition fragments.

This application is a utility application claiming priority from U.S. Provisional Application No. 60/814,568, filed Jun. 19, 2006 under the same name as above; the disclosures of the aforementioned U.S. Provisional Application is expressly incorporated herein by reference in its entirety.

### FIELD OF THE INVENTION

The invention relates generally to communications networks. More specifically, the invention relates to transmitting or receiving option information corresponding to a service in a communication network.

### BACKGROUND

Digital broadband broadcast networks enable end users to receive digital content including video, audio, data, and so forth. Using a mobile terminal, a user may receive digital content over a wireless digital broadcast network. In addition, the mobile terminal may be configured to receive electronic service guide (ESG) data and updates from an ESG service provider.

Digital content may include audio or video components. Also, any component of the digital content may include different types or options. For example, an audio file component of digital content may be provided in different languages or a subtitling component of the digital content may include text in different languages or styles. Similarly, video file components may include different images or camera angles.

In many cases, the type or option of the digital content may not be supported at a user device. A user selectable option associated with a program or service may be available during a predetermined period of time for a particular program to a user device which does not support the option. For example, a language option for a program or service may be specified as a selectable option. However, if the user device does not support the specified language option, the language option may be unavailable.

Therefore, there exists a need for a method, apparatus, and system for effectively transmitting and receiving different options or types of digital content.

### BRIEF SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a method for receiving or transmitting option information in an electronic service guide (ESG) is provided. A service fragment and/or a schedule event fragment (e.g., schedule fragment) may be transmitted or received in the ESG and the schedule event fragment may reference any number of acquisition fragments, each of the acquisition fragments associated with an option or group of options.

In another example, a transmitter or server is provided for providing option information in an ESG corresponding to a service. The transmitter or server may include an assembler for creating a service fragment, a schedule fragment (e.g., schedule event fragment), and at least one acquisition fragment corresponding to the service. The schedule fragment may include a reference to the at least one acquisition fragment for providing an option associated with an event of the service.

In another example, a first option is associated with a service and a second option is associated with an event of the service. The second option contains or includes the first option such that at least one option in the second option corresponds to at least one option in the first option. An acquisition fragment corresponding to the second option overwrites an acquisition fragment corresponding to the first option. Also, a schedule event fragment (e.g., schedule fragment) corresponding to the event may contain a reference to both acquisition fragments.

In another example, a user device is provided for receiving an option in an ESG corresponding to a service. The user device may contain an input for receiving ESG information and a module for overwriting a received option with another received option.

In another example, a tangible computer-readable medium containing executable code is provided for performing methods disclosed herein. Also, the computer-readable medium may be implemented on any device disclosed herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system 102 in which one or more illustrative embodiments of the invention may be implemented.

FIG. 2 illustrates an example of a mobile device in accordance with aspects of the present invention.

FIG. 3 is a diagram of an example transport object in accordance with at least one aspect of the present invention.

FIG. 4 illustrates an example of transmitting a plurality of single Transport Objects in accordance with at least one aspect of the present invention.

FIG. 5 is a partial block diagram illustrating an example of an ESG data model.

FIG. 6 illustrates an example of a server providing an instantiation of data or ESG fragments in accordance with aspects of the present invention.

FIG. 7 illustrates an example of multiple options provided for a program or service and selection between the choices of options in accordance with aspects of the present invention.

FIG. 8 illustrates an example in which one option provides a video with dual audio tracks in accordance with aspects of the present invention.

FIG. 9 illustrates an example in which a first option is provided as a service-related acquisition fragment and corresponding SDP in accordance with aspects of the present invention.

FIG. 10 illustrates another example in which a schedule event-related option corresponding to an event may overwrite a service-related option in accordance with aspects of the present invention.

FIG. 11 is a timing diagram illustrating the example of FIG. 8.

FIG. 12 is a timing diagram illustrating the example of FIG. 10.

FIG. 13 is a flowchart illustrating one example of a method of receiving options associated with an event, program or service in accordance with aspects of the present invention.

FIG. 14 is a partial block diagram illustrating a server for providing service-related and/or schedule event-related options corresponding to an event, program or service in accordance with aspects of the present invention.

FIG. 15 is a partial block diagram illustrating an example of a user device in accordance with aspects of the present invention.

FIG. 16 illustrates an example of an SDP file with information corresponding to a video and audio component in accordance with aspects of the present invention.

FIG. 17 illustrates another example of an SDP file with information corresponding to a video and audio component in accordance with aspects of the present invention.

FIG. 18 also illustrates an example of an SDP file describing a session of transmission of video and two corresponding audio components in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

In addition to the following, an attached appendix provides additional details of the Mobile Broadcast Open Air Interface 1.0 in which the present invention may be implemented.

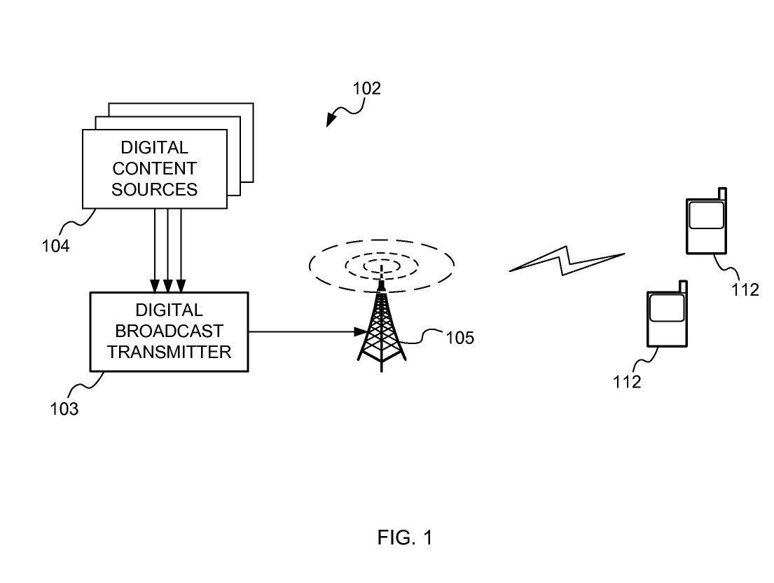

FIG. 1 illustrates a suitable digital broadband broadcast system 102 in which one or more illustrative embodiments of the invention may be implemented. Systems such as the one illustrated here may utilize a digital broadband broadcast technology, for example Digital Video Broadcast—Handheld (DVB-H) or next generation DVB-H networks such as DVB-H2. Examples of other digital broadcast standards which digital broadband broadcast system 102 may utilize include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, and ATSC, proprietary systems such as Qualcomm MediaFLO/FLO, and non-traditional systems such 3 GPP MBMS (Multimedia Broadcast/Multicast Services) and 3GPP2 BCMCS (Broadcast/Multicast Service).

Digital content may be created and/or provided by digital content sources 104 and may include video signals, audio signals, data, and so forth. Digital content sources 104 may provide content to a module (e.g., digital broadcast transmitter 103) in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission component) for wireless transmission. Ultimately, mobile terminals or devices 112 may selectively receive and consume digital content originating from digital content sources 104.

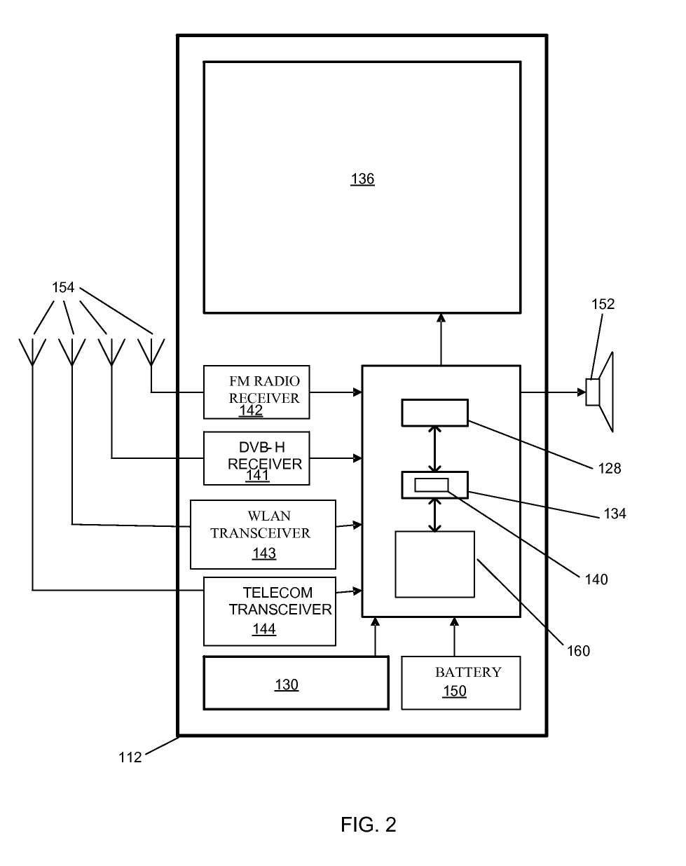

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include at least one of a keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H, DVB-H2, or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In addition, mobile device 112 may include a behavior module 160. The behavior module 160 may monitor usage of the mobile device 112 and may determine a behavior model based on the usage of the mobile device 112. For example, a user may use the mobile device 112 to watch mobile television programs on the display 136 at a particular day or time or a particular channel. In another example, ESG data corresponding to a program or service may include information of one or more channels/services (e.g. TV channels). If the ESG is identified by the channel, the behavior model may be based on the selected ESG or watched TV channels. To schedule an ESG update, as described above, statistical information describing ESG usage, including channel usage, may be collected. In another example, ESG may be delivered via other methods such as by downloading ESG information for particular channels (e.g., channels that are more actively used). Hence, in this example, channel statistics provides increased flexibility.

The behavior module 160 may detect specific information of the usage of the mobile device 112. Based on the detected usage information, the behavior module 160 may apply statistical analysis to determine a usage model which may be used to determine reception of information corresponding to a program or service. For example, the time of reception, the length of time of reception, and/or the channel of reception of program or service information may be determined in the behavior module 160 based on usage patterns. The behavior module may be implemented in hardware, software, or a combination of the two.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), or DVB-Terrestrial (DVB-T). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In addition, an electronic service guide (ESG) may be used to provide program or service related information. Generally, an electronic service guide (ESG) enables a terminal to communicate what services are available to end users and how the services may be accessed. The ESG includes independently existing pieces of ESG fragments. Traditionally, ESG fragments include XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG).

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

As stated above, the ESG fragments may be transported by IPDC over a network, such as for example, DVB-H to destination devices. The DVB-H may include, for example, separate audio, video and data streams. The destination device must then again determine the ordering of the ESG fragments and assemble them into useful information.

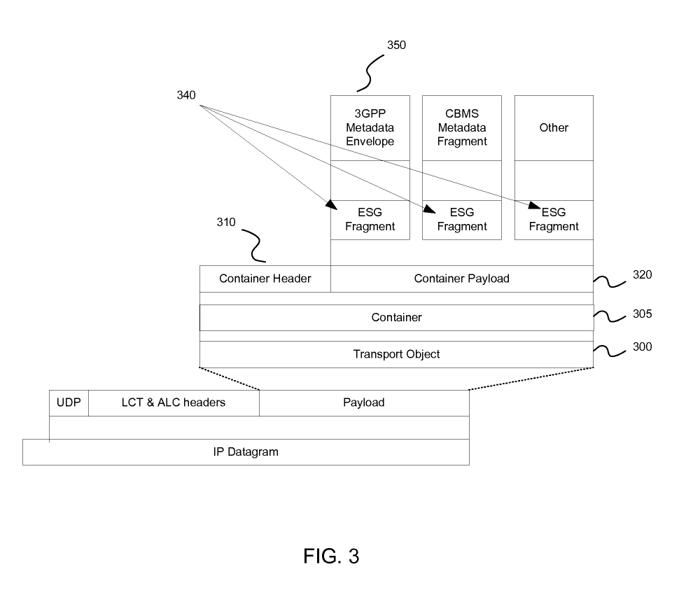

ESG fragments may be delivered in a transport object which may transport ESG information in a container. Thus, ESG fragments may be placed in a container that may be delivered in its own transport object. The container may further include a container header and a container payload, for example, in which the container header may provide information on where each container is located within the transport object. In one example, the transport object may contain a single container or a plurality of containers, each container including at least one ESG fragment. FIG. 3 is a diagram of an example transport object in accordance with at least one aspect of the present invention. As illustrated in the example of FIG. 3, a transport object 300 may comprise a container that may include a container header 310 and a container payload 320. In one example, the container header 310 and the container payload 320 are incorporated into a single container 305 which may be incorporated into a single transport object 300 so that the container header 310 need not be recombined with information regarding where each container is located within different transported objects. Alternatively, the transport object 300 may contain a plurality of containers and a container may contain any number of ESG fragments 340. The container header 310 may contain information associated with a corresponding ESG fragment such as, for example, information regarding the container header 310 itself and/or the container payload 320.

In the example illustrated in FIG. 3, the ESG fragment 340 is contained in the container payload 320. The container header 310 may contain descriptors for identifying and describing ESG fragments in the corresponding container payload 320. Thus, the characteristics of the ESG fragment may be identified, such as but not limited to the position of the ESG fragment in the transport object 300 or the length of each contained ESG fragment 340. For example, in one embodiment, a field specifies where the particular ESG begins within the container payload 320 by providing, for example, an offset value, start and end points, or the like. In other embodiments, metadata 350 may be associated with the individual ESG fragments 340, located within or proximate to the header 310, descriptor entries, an ESG fragment 340 or a mixture thereof. In one exemplary embodiment, the association of a 3GPP metadata envelope with an ESG fragment 340 may substitute for, or negate the need of additional metadata to be located in the header 310 in relation to that particular ESG fragment.

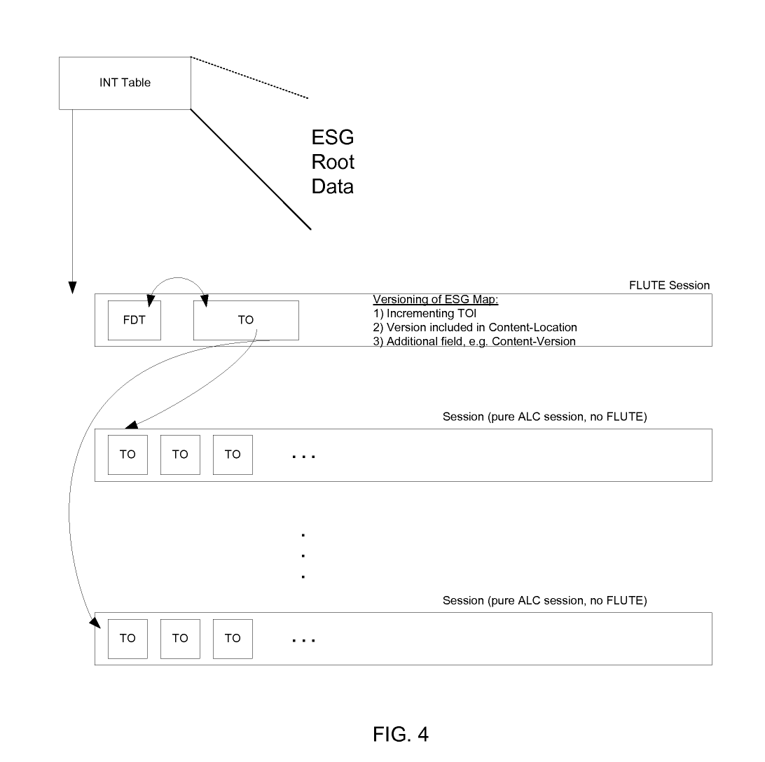

FIG. 4 illustrates an example of transmitting a plurality of single Transport Objects. As illustrated in FIG. 4, the Transport Objects (TO) may be carried in, for example, FLUTE (File Delivery over Unidirectional Transport) sessions, or a pure Asynchronous Layered Coding (ALC) session. In the example of FIG. 4, the ESG Root Channel data, such as IP Address, port number and Transport Session Identifier (TSI), are announced in the IP/MAC Notification Table (INT Table) which may be, for example, carried in the SI/PSI stream in DVB-H as one of the SI tables of DVB-H. The FLUTE session of the ESG Root Channel comprises a File Delivery Table (FDT) of the session and one or more Transport Objects (TO). These Transport Objects that may be delivered in announcement carousels contain mapping between the different parts of ESGs and access parameters to the different ESG methods in which the ESG data is transmitted.

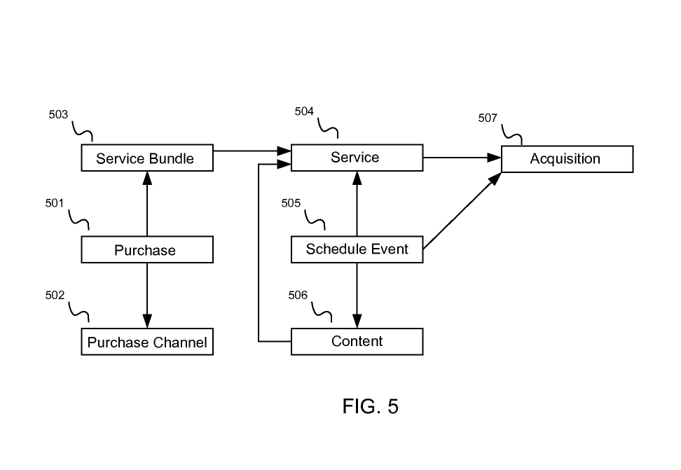

FIG. 5 is a partial block diagram illustrating an example of an ESG data model. In this example, the ESG includes a purchase fragment corresponding to a program or service. The purchase fragment 501 may include purchase information for display to a user. Also, the purchase fragment 501 may include information for making an actual purchase associated with the corresponding program or service. In addition, the ESG model may further include a purchase channel fragment for indicating a purchase channel (i.e., an interface through which a user may interact with the purchase system). For example, the purchase channel fragment 502 may include a name and/or description of a purchase channel operator or other parameters corresponding to the purchase system.

The ESG model may further include a service bundle fragment 503 and a service fragment 504. The service fragment 504 may describe a service for an end user. The service fragment may further include a reference to one or more corresponding acquisition fragment(s) in which the acquisition fragment(s) may specify generic information for the acquisition of the service. In one example, the acquisition fragment referred to by the service fragment 504 may be overwritten by other acquisition fragments that may be referenced by schedule event fragments as described below.

Examples of services for a user may include a traditional television channel or a service for supplying a ring tone. The service fragment 504 may further include other information pertaining to the service such as a name, number, logo, description, type, etc. In addition, a service bundle fragment 503 may specify a bundle of services. For example, the service bundle fragment may provide information corresponding to a group of items that is offered to a user.

Also, a program or service may be provided at a predetermined time. The ESG model illustrated in FIG. 5 contains a schedule event fragment 505 for specifying the broadcast time of a scheduled item of a service. At the indicated broadcast time, the program or service may be provided or displayed to the user. In addition, the schedule event fragment 505 may include a reference to an acquisition fragment, the acquisition fragment describing a format or parameters for a content item. Also, in one example, the schedule event fragment 505 may include references to multiple acquisition fragments as described herein.

The ESG model may further include a content fragment 506 that may contain metadata for describing the content. Also, the ESG model may include an acquisition fragment 507 for specifying information to access a service or content. The acquisition fragment may further indicate the instantiation of a Session Description element to enable identification of a session carrying content of interest. This session may be described by a Session Description Protocol (SDP), such as a description of a session which may include a name, protocols, formats, timing, etc. of the session.

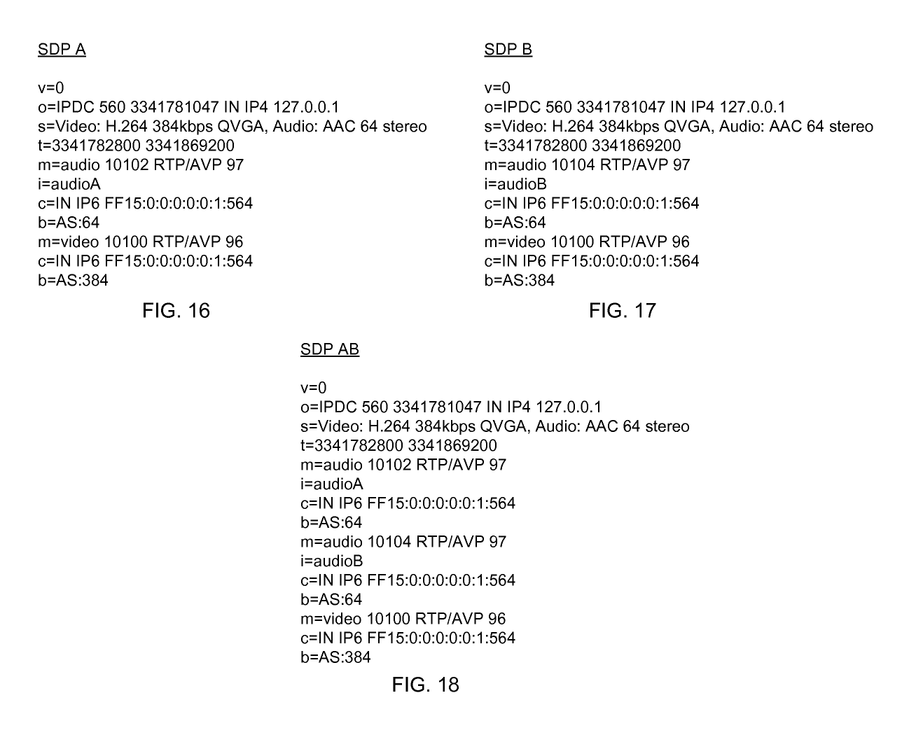

FIG. 16 illustrates an example of an SDP file. The SDP file is labeled as “SDP A” and provides information on a session in which content is provided to a user device. In this example, the content contains video and audio. One audio stream is described in the SDP A file of FIG. 16 as “audioA.” FIG. 17 illustrates another example of an SDP file (i.e., SDP B). In this example as in the example of FIG. 16, content described by the SDP B file includes video and audio. However, in this example, the audio content is indicated as “audioB” which may be a different audio component than “audioA.” FIG. 18 also illustrates an example of an SDP file in which the session described includes transmission of video and two audio components. This SDP file is labeled as SDP AB and contains two audio components. The two audio components are indicated as “audioA” and “audioB” as indicated in FIG. 18. Hence, the service which SDP AB describes contains a video component and two audio components. For example, one audio component may be in one language and the other audio component may be in another language.

A service fragment may be linked to any number of acquisition fragments and may also be linked to a schedule event fragment. The schedule event fragment may also be associated to any number of acquisition fragments. A program or service may be provided to a user at a user device in which the program or service includes a corresponding option. As one example, the option may be a language in which the program or service is provided.

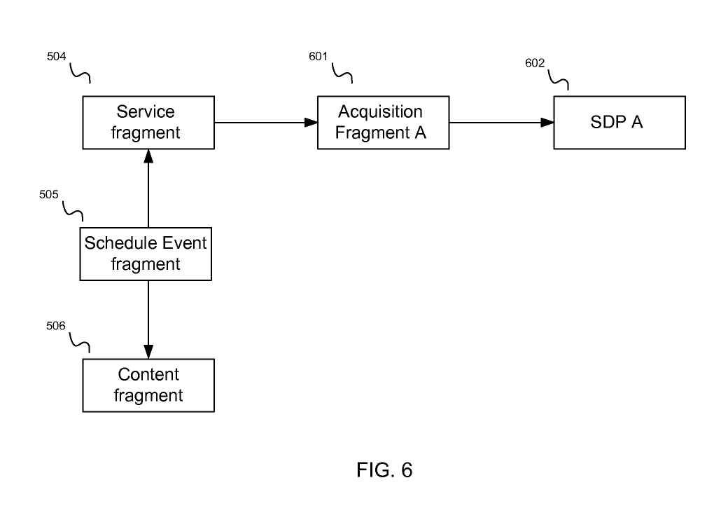

FIG. 6 illustrates an example of a server providing an instantiation of data or ESG fragments corresponding to the program or service and corresponding option. In this example, a schedule event fragment 505 provides information on a broadcast time of a scheduled item. The scheduled item may be a content item of a service as in this example. The content fragment 506 provides metadata describing the content of the program or service. Also, a service fragment 504 may be included for providing the service (e.g., IPDC service) corresponding to the program or service provided to the user and may include a reference to acquisition fragment A 601. In this example, one service-related option is declared in acquisition fragment A 601 that specifies access information to the service or content. The service-related option may be any type corresponding to the content of the program or service. For example, the service-related option may be a declared language in which the program or service is provided. As FIG. 6 illustrates, one language (i.e., option) has been declared in Acquisition Fragment A 601. The server may instantiate the ESG fragments of the program or service with a corresponding SDP for providing information on the session. The SDP (i.e., SDP A 602 in this example) is provided to the user at the user device. The user device thus receives the service and corresponding access information in the acquisition fragment A 601. In this example, only one option is provided for the user and hence, the user does not select options.

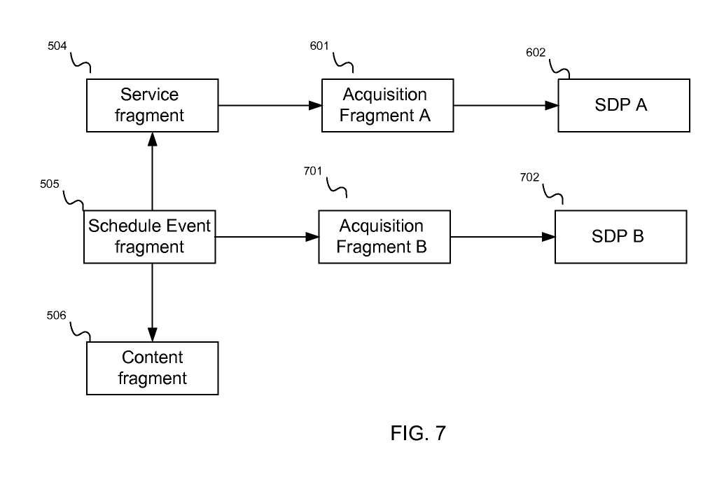

In another example, multiple options associated with a program or service are provided with the program or service. A user at a user device may select a preferred or desired option from a plurality of options. FIG. 7 illustrates an example of multiple options provided for a program or service and selection between the choices of options. Service fragment 504 contains a reference to acquisition fragment A 601 and schedule event fragment 505 includes a reference to acquisition fragment B 701. In this example, a first option (option A) is a service-related option and is provided in Acquisition Fragment A 601 (which is referred to by the service fragment 504). Also, a second option (option B) is a schedule event-related option and is provided in Acquisition Fragment B 701 (which is referred to by the schedule event fragment 505). Based on the options (e.g., option A or option B), a corresponding SDP may be provided to the user device such as SDP A 602 or SDP B 702. For example, a user may select an option such as option A. If the user selects option A, then SDP A 602 and the corresponding acquisition fragment A 601 is provided to the user device from the server. Conversely, if the user selects option B, then SDP B 702 and the corresponding acquisition fragment B 701 is provided to the user device from the server. Thus, in this example, a user may select an option from a plurality of options with additive SDP handling. In the example of FIG. 7, two separation options are instantiated.

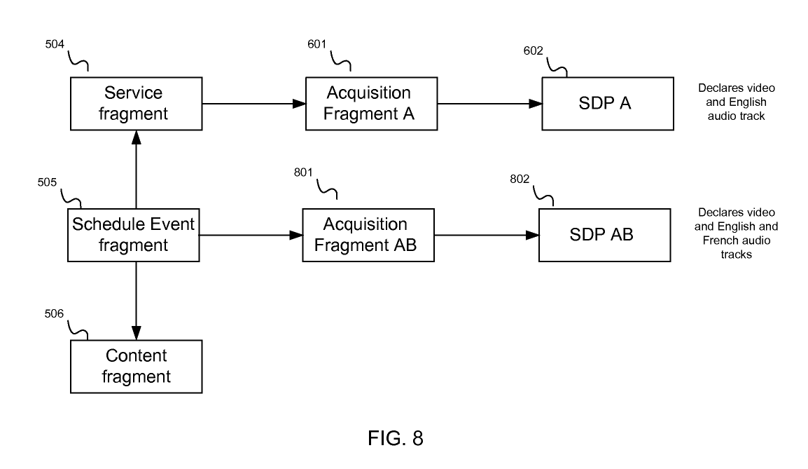

In another example, multiple options are provided with a program or service to a user terminal and a schedule event-related option overwrites a service-related option. FIG. 8 illustrates an example in which one option provides a video with dual audio tracks such as an English language audio track and a French language audio track. The option overwrites another option for a particular event in which only an English language audio track is provided. As FIG. 8 illustrates, service fragment 504 contains a reference to acquisition fragment A 601 and schedule event fragment 505 contains a reference to acquisition fragment AB 801. Service fragment-related Acquisition Fragment A 601 provides one option associated with SDP A 602. Acquisition fragment A 601 and corresponding SDP A 602 provides video with only an English language audio track.

Also illustrated in FIG. 8, a second schedule event-related option corresponding to the program or service is provided to the user at the user device in Acquisition Fragment AB 801 with corresponding SDP AB 802. The schedule event-related option may correspond to a particular event and may overwrite the service-fragment-related option. In this example, the schedule event-related option includes a declaration that the video contains an audio track in both the first language (English) and a second language such as French. Hence, when an event occurs in which an English and a French audio track are available, the schedule event-related option may overwrite the service-related option in which only an English language audio track is provided. FIG. 8 is an example where the overwrite option may be implicitly signaled (e.g., the user device or terminal may decide whether to overwrite based on predetermined criteria.)

If the user device supports the first option (i.e., English language broadcast with the video) but does not support the second language (i.e., French), then the SDP AB 802 corresponding to the audio in both English and French is inserted into the application. The application may generate separate SDP A and SDP B based on information carried in SDP AB. After generating the separate SDP A (i.e., English language in this example) and SDP B (i.e., French language in this example), each SDP A and/or SDP B may be transmitted to the user device. Which SDP to transmit may depend on a user preference or a selection of an option, for example. In this example, some information may be duplicated such as information in SDP A and SDP AB because both SDP A and SDP AB may contain information corresponding to the first option A.

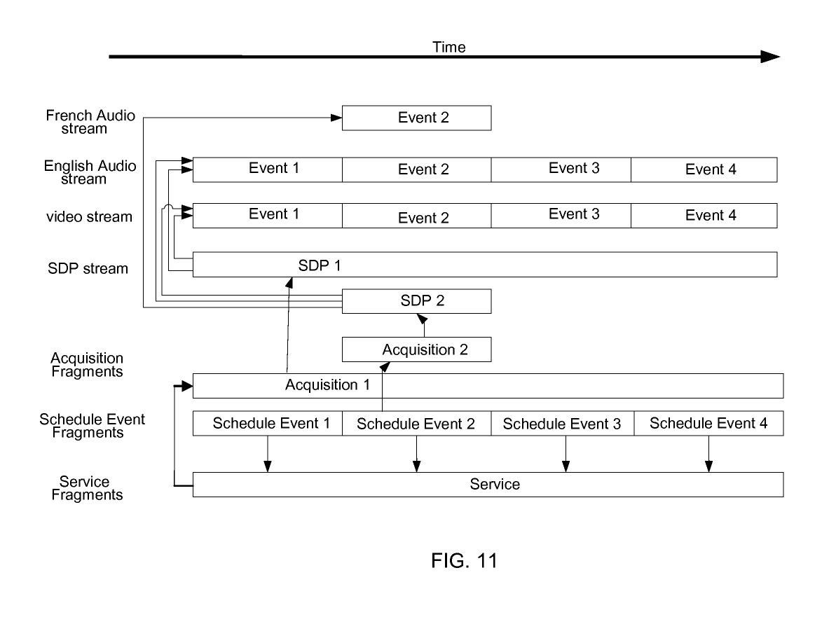

FIG. 11 is a timing diagram illustrating the example of FIG. 8. The service fragment contains information describing the service. This may include, for example, a traditional TV channel or a service. Schedule event fragments, of which four are illustrated in FIG. 11, may provide scheduling information of a program or service. Schedule event 1 provides scheduling information corresponding to event 1 and schedule event 2 provides scheduling information corresponding to event 2, for example.

In this example, a TV service may include any of two audio tracks—one in English and one in French. The predominant audio track is in the English language; however, certain events, such as event 2 in this example, may also be provided with a French audio track. For example, event 1 may include only an English audio stream with the corresponding video and may be described by SDP file SDP 1. Also, SDP1 may be referred to by acquisition fragment 1 (“Acquisition 1”). As FIG. 11 illustrates, SDP 1 provides a video stream and an English Audio stream. In addition, each of Event 2, Event 3, and Event 4 each provide a video stream and an English Audio stream.

However, a second event (e.g., event 2) may include both an English audio track and a French audio track. Event 2 is described by SDP file SDP 2 which may be referred to by acquisition fragment 2 (“Acquisition 2”). Hence, event 2 is associated with a schedule event-related option (both English and French audio tracks) as indicated in FIG. 11 by the arrow between the schedule event 2 and acquisition 2 blocks. Event 2 contains a French audio stream and is described by SDP 2. However, Event 1, Event 3 and Event 4 do not include a French audio stream.

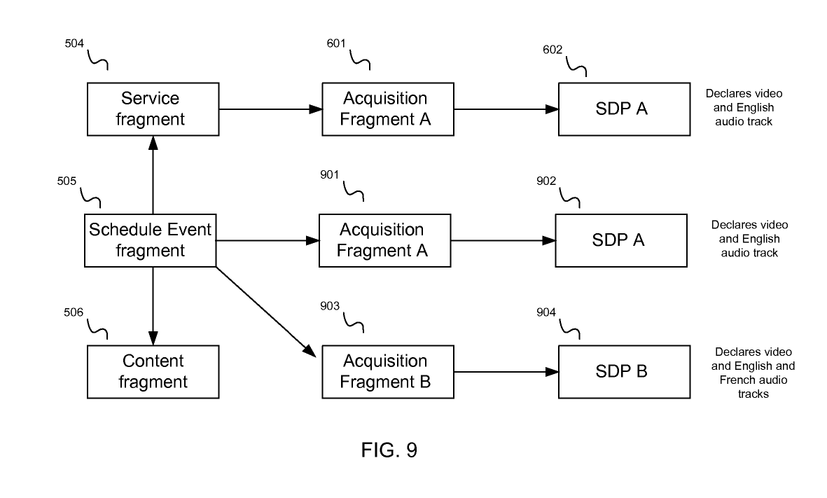

In another example of the present invention, a service-related option may be overwritten by a schedule event-related option to provide both additive and overwriting SDP handling. FIG. 9 illustrates such an example in which a first option, such as a video with an English audio track is provided as a service-related acquisition fragment A 601 and corresponding SDP A 602. Service fragment 504 contains a reference to acquisition fragment A 601 which contains data corresponding to the first option (i.e., video with an English audio track). In addition, the schedule event fragment 505 contains a reference to acquisition fragment A 901 and acquisition fragment B 903. A schedule event-related option may provide an option for an event in which the video of the event also includes a French audio track. In this example, the schedule event-related option may be added to provide acquisition fragment A 901 and corresponding SDP A 902 (via schedule event fragment 505) for the video and English language audio track and acquisition fragment B 903 and corresponding SDP B 904 (via schedule event fragment 505) for the video and French language audio track. FIG. 9 is an example where the overwrite option may be implicitly signaled (e.g., the user device or terminal may decide whether to overwrite based on predetermined criteria.) Acquisition fragment A 601 and acquisition fragment A 901 may be slightly different from each other, wherein acquisition fragment B 903 may be totally different from the other fragments 601, 901 (e.g., in the case of different languages A and B may be audio streams in different languages, while fragments 601 and 901 may differ by, for example, audio quality but are in the same language.)

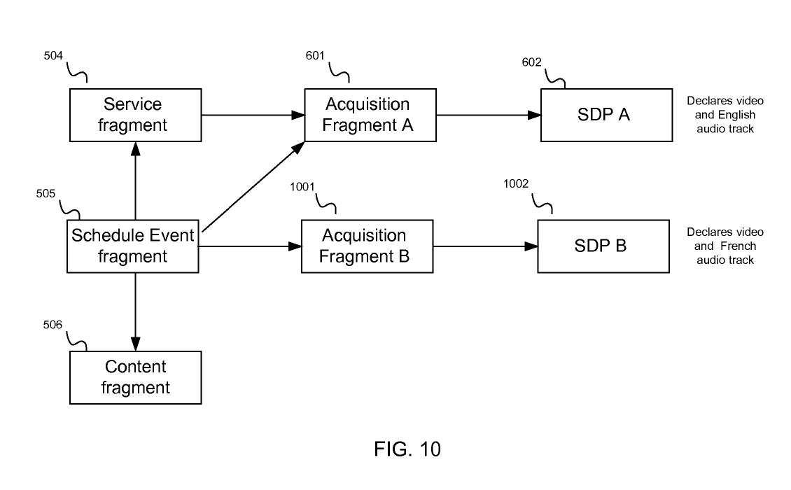

FIG. 10 illustrates another example in which a schedule event-related option corresponding to an event may overwrite a service-related option. In this example, when an option has been added, the schedule event fragment 505 references both acquisition fragment A 601 and acquisition fragment B 1001. Hence, in this example, the service fragment contains a reference to a first option and the option corresponding to the schedule event fragment 505 may overwrite the option corresponding to the service fragment 504. However, when an option is added to the schedule event related option, the schedule event fragment 505 may reference both acquisition fragment A 601 and acquisition fragment B 1001. Thus, handling of SDP files is simplified and duplication of data is minimized.

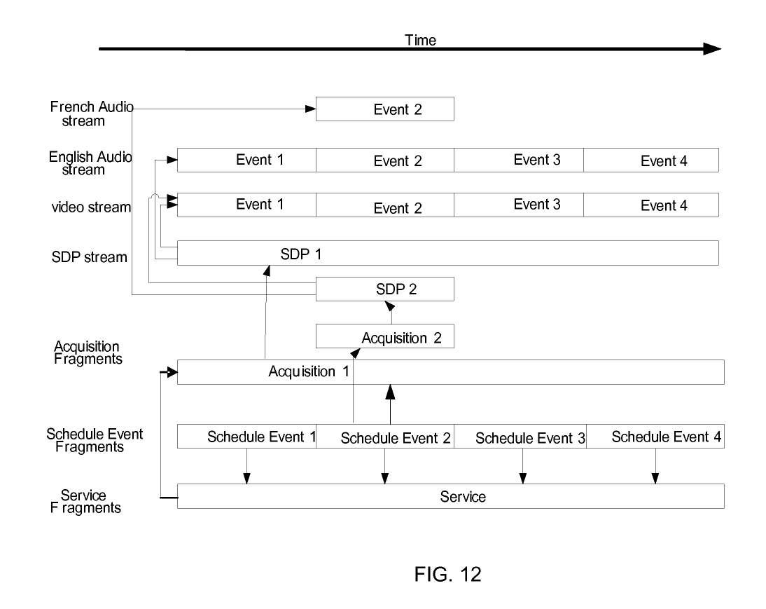

FIG. 12 is a timing diagram illustrating the example of FIG. 10. Event 1 corresponds to the service fragment and the service fragment contains a reference to acquisition 1. Acquisition 1 contains a reference to corresponding SDP 1 for providing a first option. In this case, the first option includes a video stream and an English audio stream. However, the first option does not include a French audio stream. Event 2 in this example provides video with both an English audio stream and a French audio stream. Thus, event 2 provides an added option of a French audio stream. Event 2 provides for an English audio stream and therefore contains a reference to acquisition 1 because acquisition 1 and corresponding SDP 1 provides for an option in which a video stream and an English audio stream is provided to the user. However, event 2 also provides for an added option of a French audio stream and therefore contains a reference to acquisition 2, which corresponds to SDP 2. As FIG. 12 illustrates, Acquisition 2 and corresponding SDP 2 provide for the video stream and a French Audio stream.

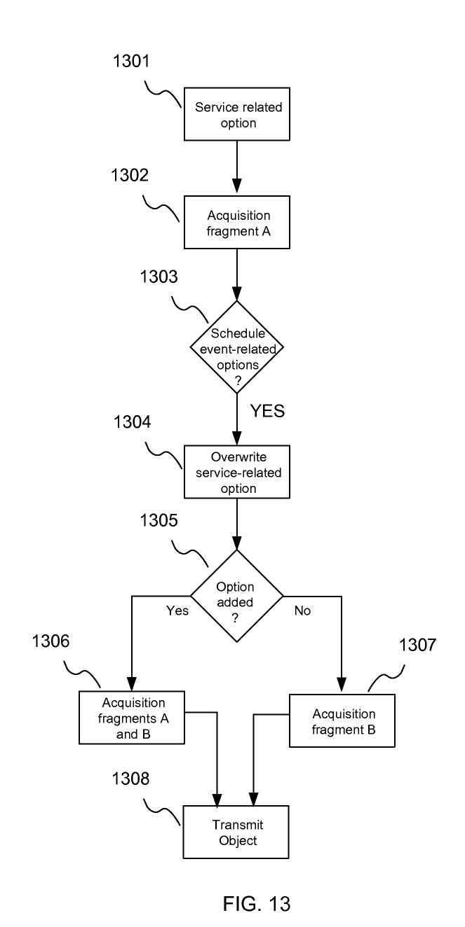

FIG. 13 is a flowchart illustrating one example of a method of receiving options associated with an event, program or service. In STEP 1301, a service related option associated with an event is received. For example, a program containing video and audio may be received at a user device such as a mobile terminal. The received program information may include an option that may be selected by a user or may be predetermined. One example of an option is an audio track in a particular language. For example, the program may contain video and an English language audio track. The program is associated with an acquisition fragment and corresponding SDP data for indicating the program options that are available. In this case, the acquisition fragment and corresponding SDP data provide information on the video and audio track of the corresponding program.

Based on the received service-related option, the corresponding acquisition fragment A is received at the user device (STEP 1302). As set forth above, the acquisition fragment A may provide information on program options available and may further be associated with SDP data for describing the session over which the program is received.

For a given event, such as a time of availability of a program or service or a particular program or service provided at a scheduled time, a new or different option or set of options may be provided. For example, a first program may be associated with the service-related option as described above and a second program or service may be transmitted to the user device at a predetermined time with at least one option that is different from options associated with the first program. The options associated with the second program may further be a schedule event-related option (e.g., options associated with the particular event or program, in this case the second program). As one example, the first program or service may have an option of video and an English language audio track and the second program or service may have an option of video and either an English language audio track or a French audio track. A user at the user device may select either the English language audio track or the French audio track based on user preferences. Hence, in this example, the second program or service has an associated schedule event-related option of the video with both the English and French audio track.

As FIG. 13 illustrates, the schedule event-related option may be detected in STEP 1303 (“YES” branch of STEP 1303). If the schedule event-related option is detected, the service-related option overwrites the service related option (STEP 1304) such that the service-related option is provided to the user device. In the example above, the program or service is provided to the user device with an option of the video with an English language audio track or a French language audio track. Alternatively, the service-related option is used if no schedule event-related options are detected.

In addition, the schedule event-related option may be compared to the service-related option in STEP 1305 to determine if an option was added, subtracted, or otherwise modified. If an additional option is detected in the service-related option that was not present in the service-related option, then a corresponding acquisition fragment may be referenced. As FIG. 13 illustrates, an additional option may be detected (“YES” branch of STEP 1305) in which the additional option corresponds to acquisition fragment B. The schedule event fragment may thus reference both acquisition fragment A and the acquisition fragment corresponding to the added option (i.e., acquisition B in this example) (STEP 1306). Alternatively, if no additional options are detected, then the previous acquisition fragment (i.e., acquisition fragment A in this example) may be referenced via the schedule event fragment (STEP 1307). In STEP 1308, one or more objects comprising the acquisition fragments (e.g., service-related acquisition fragment, schedule event-related acquisition fragment, etc.) may be transmitted.

In an example to illustrate, a first event, program or service may be provided to a user device, the first event, program or service having an option of video with an English language audio track (and no French language audio track) (STEP 1301). The service-related option is described in a corresponding acquisition fragment (acquisition fragment A in this example) which may further reference corresponding SDP information for providing the video and English language audio track option to the user at the user device (STEP 1302). A second event may then be transmitted from a server to a user device in which the second event is associated with a schedule event-related option (STEP 1303). For example, the schedule event-related option associated with the second event may include an option of video with either an English language audio track or a French language audio track. Hence, a user at the user device may select either the English language audio track or the French language audio track based on user preferences. The schedule event-related option overwrites the service related option (STEP 1304) so that the additional option of having the French language audio track associated with the second event is available. Also, an added option is detected (i.e., the French language audio track) (STEP 1305). Hence, the schedule event fragment may reference the original acquisition fragment A (for the English language audio track option) and additionally may reference a second acquisition fragment associated with the added option of having the French language audio track (i.e., acquisition fragment B in this example (STEP 1306).

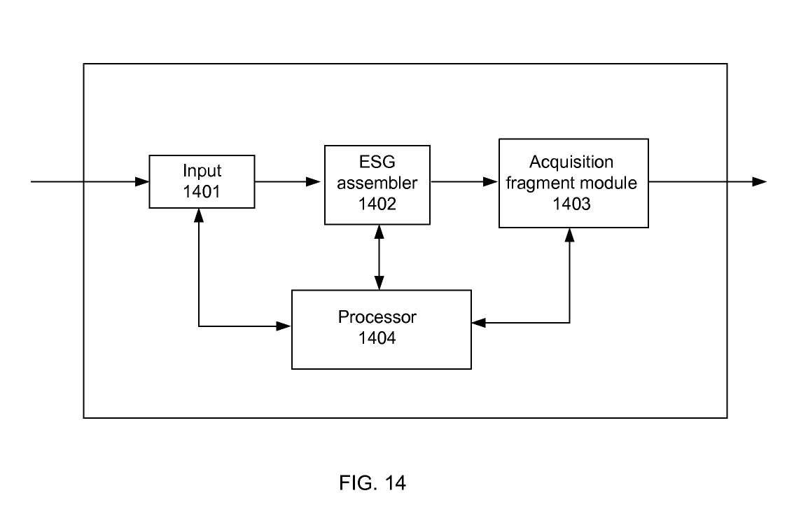

FIG. 14 is a partial block diagram illustrating a server for providing service-related and/or schedule event-related options corresponding to an event, program or service. The server in this example includes an input 1401 for receiving content data for transmitting to a user device and data corresponding to the content data, such as ESG data, for describing the content data. Based on this data, ESG data corresponding to the content data including acquisition fragment and corresponding SDP information may be transmitted from the server to the user device for providing options corresponding to the content data to the user.

The input 1401 provides the received data to an ESG assembler 1402, which assembles the data in an ESG model. The ESG model may include various data fragments including an acquisition fragment for describing options associated with program or service content data. Additionally, the server may include an acquisition fragment module 1403 for assembling the ESG model with an acquisition fragment. The acquisition fragment module 1403 may insert a reference to the acquisition fragment in a data fragment of the ESG data model. For example, the ESG model may include a service fragment and/or a schedule event fragment and the acquisition fragment module 1403 may insert a reference to the acquisition fragment in the service fragment and/or the schedule event fragment. In addition, the service fragment may be linked to the schedule event fragment for a particular program or service and the service fragment may be linked to any number of acquisition fragments. Also, the associated schedule event fragment may be associated with any number of acquisition fragments.

In one example, a program or service with a corresponding option is provided by the server. A service fragment is provided in the ESG data corresponding to the program or service and the acquisition fragment module 1403 creates a corresponding acquisition fragment for specifying information (e.g., access information or option information) for the program or service. In addition, the acquisition fragment module 1403 may provide a reference to the acquisition fragment in the service fragment to create a service-related acquisition fragment. Alternatively, any other component of the transmitter may provide the reference to the acquisition fragment in the service fragment. For example, the ESG assembler 1402 or processor 1404 may also insert the reference to the service-related acquisition fragment into the service fragment. If an event having an additional option is received and transmitted from the server to a user device, the ESG assembler 1402 may provide a schedule event fragment in the ESG model corresponding to the event. Also, the acquisition fragment module 1403 may create a corresponding acquisition fragment associated with the event and may further insert a reference to the acquisition fragment in the schedule event fragment. Also, the acquisition fragment module 1403 may include a reference to corresponding SDP information for providing the option to the user device. Any of the components of the server may be controlled or monitored by the processor 1404.

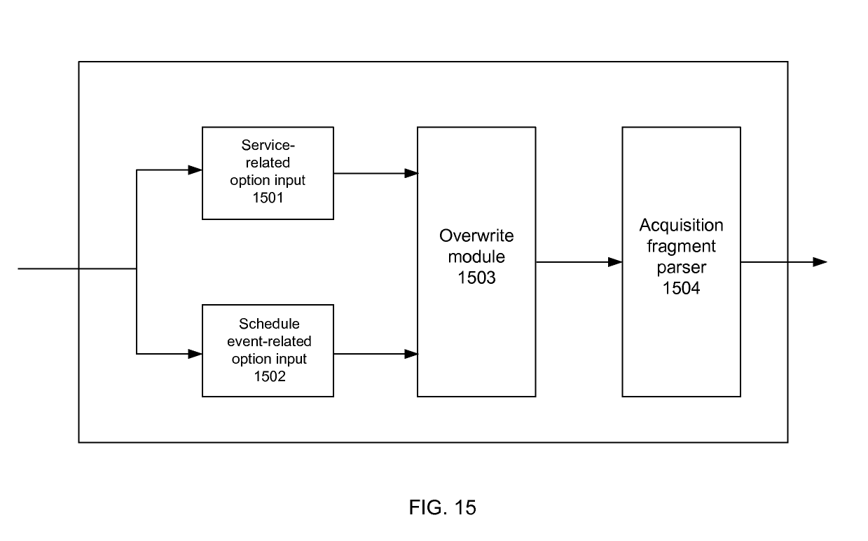

FIG. 15 is a partial block diagram illustrating an example of a user device such as a mobile terminal. The user device may include an input 1501 for receiving service-related options and an input 1502 for receiving schedule event-related options. Alternatively, input 1501 and input 1502 may be in a single input for receiving data including the option information. The service-related option may be described in a corresponding service-related acquisition fragment which may be referenced by a corresponding service fragment. The service-related acquisition fragment may further refer to an SDP for describing the available options. The schedule event-relate option input 1502 may receive a schedule event fragment corresponding to a schedule-related acquisition fragment. An overwrite module 1503 overwrites the service-related acquisition fragment with the schedule event-related acquisition fragment for providing the options that correspond to the event. Also, an acquisition fragment parser 1504 may be included in the user device for comparing the service-related option and the schedule event-related option as provided in the corresponding acquisition fragments to determine additional options in the schedule event-related option. For example, the acquisition fragment parser 1504 may determine additional references in the schedule event fragment of the ESG data corresponding to the program or service to multiple acquisition fragments. As one example, the schedule event fragment may reference the service-related acquisition fragment and the schedule event-related acquisition fragment if an additional option is detected in the schedule event-related options as compared to the service-related option.

The schedule event-related acquisition fragments (Acq) can be additive or overwritten in relation to service-related ones. In case of additive handling, a user terminal has an easy task to pick-up the options (one Acq, one option). In an overwriting case, all the options can be included in one (AB) Acq, which means that an API can be provided for option selection in the terminal. Consequently, according to various embodiments, two possibilities can be combined into one as depicted in FIGS. 10 and 12. The schedule event-related options are overwriting in relation to service-related ones, but additive in relation to each others. So if there is a service-related Acq A and schedule related-acquisitions Acqs B and C, one could arrange them as follows:

(1) service-related A and schedule event-related ABC or (2 Acq fragments and 2 corresponding SDP files in total)

(2) service-related A and schedule event-related B+C (3 Acq fragments and 3 corresponding SDP files in total)

(3) service-related A and schedule event-related AB+C (3 Acq fragments and 3 corresponding SDP files in total)

(4) service-related A and schedule event-related A+B+C (4 Acq fragments and 4 corresponding SDP files in total)

(1) relates to an overwriting solution (ABC). (2) relates to an additive solution (A+B+C). (3) and (4) relate to various embodiments described herein. One problem in cases (1), (3) and (4) is that information about Acq A will be sent twice every time ESG has been sent. This is because even if service-related and schedule event-related acquisitions include the same information they are two separate instances/objects. This can be avoided in case (4) by optimising transmission, so that both service and schedule event fragments refer to same instance/object of Acq A.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. The invention also includes a tangible computer-readable medium having computer-executable instructions for performing any of the methods herein, and may be implemented on any of various devices, such as a SIMM card, flash memory, HD, RAM, ROM, firmware, ASIC, FPGA, etc.

We claim:

1. A method comprising:
inserting in a service fragment in an electronic service guide a reference to a service-related acquisition fragment comprising a first option associated with a service; and
inserting in a schedule event fragment in the electronic service guide a reference to a schedule event-related acquisition fragment and a reference to the service-related acquisition fragment, the schedule event-related acquisition fragment comprising a second option associated with the event,
wherein the second option comprises the first option.

2. The method of claim 1, wherein the service fragment does not contain a reference to the schedule event-related acquisition fragment.

3. The method of claim 1, wherein the first option includes a selectable option.

4. The method of claim 1, wherein the second option includes a predetermined option.

5. The method of claim 1, further comprising transmitting a plurality of objects comprising the service-related acquisition fragment and the schedule event-related acquisition fragment.

6. The method of claim 1, wherein the first acquisition fragment includes at least one of: a SDP file, an XML file, and an image file.

7. A method comprising:
receiving a service fragment in an electronic service guide, the service fragment containing a reference to a corresponding service-related acquisition fragment, the service-related acquisition fragment containing a first option associated with a service;
receiving a schedule event fragment in the electronic service guide, the schedule event fragment comprising a reference to a corresponding schedule event-related acquisition fragment, the schedule event-related acquisition fragment comprising a second option associated with an event; and
overwriting the first option with the second option,
wherein the second option comprises the first option, and the schedule event fragment references the service-related acquisition fragment and the schedule event-related acquisition fragment.

8. The method of claim 7, wherein the service fragment does not reference the schedule event-related acquisition fragment.

9. The method of claim 7, wherein the first option includes a predetermined option.

10. The method of claim 7, wherein the first acquisition fragment includes at least one of: a SDP file, an XML file, and an image file.

11. An apparatus comprising:
an input for receiving content data and corresponding option information;
an assembler for creating a service fragment, a schedule event fragment, and at least one acquisition fragment corresponding to a service, wherein an option in an electronic service guide corresponds to the service;
a module for associating a first option with the service and a second option with an event of the service, the second option including the first option,
wherein a first acquisition fragment is associated with the first option and referenced by the service fragment and the schedule event fragment, and a second acquisition fragment is associated with the second option.

12. The apparatus of claim 11 wherein the second acquisition fragment is referenced by the schedule event fragment.

13. The apparatus of claim 11 wherein the second acquisition fragment is not referenced by the schedule event fragment.

14. The apparatus of claim 11, wherein the first option includes a selectable option.

15. The apparatus of claim 11, wherein the second option includes a predetermined option.

16. The apparatus of claim 11, wherein the module is configured to transmit a plurality of objects comprising the first acquisition fragment and the second acquisition fragment.

17. The apparatus of claim 16, wherein the first acquisition fragment includes at least one of: a SDP file, an XML file, and an image file.

18. A mobile terminal comprising:
an input for receiving a service fragment in an electronic service guide, the service fragment comprising a reference to a service-related acquisition fragment corresponding to a first option;
an input for receiving a schedule event fragment in an electronic service guide, the schedule event fragment comprising a reference to a schedule event-related acquisition fragment corresponding to a second option and a reference to the service-related acquisition fragment; and
a module for overwriting the first option with the second option.

19. The mobile terminal of claim 18, wherein the service-related acquisition fragment includes at least one of: a SDP file, an XML file, and an image file.

20. The mobile terminal of claim 18, wherein the schedule event-related acquisition fragment includes at least one of: a SDP file, an XML file, and an image file.

21. A system comprising:
an apparatus configured for receiving content data and corresponding option information, and creating a service fragment, a schedule event fragment, and at least one acquisition fragment corresponding to a service;
a mobile terminal configured for receiving the service fragment and the schedule event fragment;
wherein a first option is associated with the service, a second option is associated with an event of the service, a first acquisition fragment is associated with the first option and referenced by the service fragment and the schedule event fragment, and a second acquisition fragment is associated with the second option; and
wherein the mobile terminal overwrites the first option with the second option.

22. The system of claim 21, wherein the first option includes a selectable option.

23. The system of claim 21, wherein the first acquisition fragment includes at least one of: a SDP file, an XML file, and an image file.

24. A tangible computer-readable medium containing executable code for performing a method comprising:
receiving a service fragment in an electronic service guide, the service fragment comprising a reference to a corresponding service-related acquisition fragment, the service-related acquisition fragment comprising a first option associated with the service;
receiving a schedule event fragment in an electronic service guide, the schedule event fragment containing a reference to a corresponding schedule event-related acquisition fragment, the schedule event-related acquisition fragment containing a second option associated with an event; and
overwriting the first option with the second option,
wherein the second option contains the first option and the schedule event fragment references the service-related acquisition fragment and the schedule event-related acquisition fragment.
